(19) United States
(12) Patent Application Publication
(10) Pub. No.: US 2001/0020403 A1
(43) Pub. Date: Sep. 13, 2001

(54) Ratchet wrench with T-bar

(76) Inventor: Phillip Jarrett, Bramhall (GB)

Correspondence Address: MR P JARRETT, 74 ADELAIDE ROAD, BRAMHALL, SK7 ILU, GB

(21) Appl. No.: 09/738,382

(22) Filed: Dec. 18, 2000

(30) Foreign Application Priority Data
Jan. 7, 2000 (GB) GB 0000 246.9
Jul. 19, 2000 (GB) GB 00 17597.6

(51) Int. Cl. B25B 13/46

(52) U.S. Cl. 81/60

(57) ABSTRACT

A ratchet wrench having two in-line torque bars 23 and 24 which also serve as the lever bars for an integral T-bar wrench; whereas, the torque bar 21 of the T-bar wrench also serves as the lever bar of the ratchet wrench. One or more of the bars can be extended to provide increased leverage and the outer tubes 28 or 36 may be tightly gripped to steady the tool whilst allowing the torque bars to freely rotate. The ratchet wrench and T-bar combination provides the user with a single versatile hand tool having variable reach, given that bar 21 is significantly longer than bar 23 or 24, without the need to add an extension torque bar. The ratchet mechanism is located in the housing 22 and may comprise a non-adjustable one-way drive, incorporating deeply cut ratchet teeth to provide a high strength tool.

### CROSS REFERENCE TO RELATED APPLICATIONS

GB 0000246.9 filed in the UK on Jan. 7, 2000

GB 0017597.6 filed in the UK on Jul. 19, 2000

### STATEMENT REGARDING FEDERALLY SPONSORED RESEARCH OR DEVELOPMENT

Not Applicable

### REFERENCE TO MICROFICHE APPENDIX

Not Applicable

### BACKGROUND TO THE INVENTION

The present invention relates to a ratchet wrench having an integral T-bar wrench.

Throughout the following specification and claims, any reference to a nut is to be construed as including bolts, or, other types of fastenings such as cap screws when using suitable socket head attachments.

Both the ratchet wrench and T-bar wrench are well known hand tools typically used by mechanics and similar trades. The ratchet wrench normally requires the addition of an extension torque bar to increase its reach and, due to the limited strength of the ratchet, has a relatively short lever bar. On the other hand, the T-bar wrench often has a fairly long reach and has two lever bars, both of which may be gripped to steady the T-bar and increase the applied leverage.

### BRIEF SUMMARY OF INVENTION

One objective of the present invention is to combine both kinds of wrench into one integrated tool, providing the user with a single versatile hand tool having a variable reach without the addition of extension torque bars. In other words, only one hand tool needs to be carried by the mechanic, instead of two separate wrench tools along with various extension torque bars.

A second objective is to provide a strong and long life tool capable of applying increased leverage when necessary.

A third objective is to provide comfortable means to steady the ratchet wrench when applying increased leverage.

A fourth objective is to provide comfortable means to steady the T-bar wrench during nut spinning.

A fifth objective is to provide a tool capable of optional disassembly for compact storage purposes.

According to the present invention, there is provided a ratchet wrench having two oppositely facing torque bars which may be integrally connected, the torque bars being disposed along a common longitudinal axis, each torque bar having a drive head for engaging a suitable socket head; the torque bars combining to form the lever bars of an integral T-bar wrench having a single drive head for engaging a suitable socket head, the torque bar of the T-bar wrench being or capable of being when fully extended of significantly longer length than either of the ratchet wrench torque bars.

### BRIEF DESCRIPTION OF THE SEVERAL VIEWS OF THE DRAWINGS

Some specific embodiments of the present invention will now be described, as examples, with reference to the accompanying drawings:

FIG. 1 shows one embodiment of the ratchet wrench, with the ratchet mechanism located at the point of intersection of the T-shaped configuration, having a sliding tube to provide increased ratchet wrench leverage and two in-line integrally connected torque bars having hand grips;

FIG. 2 shows a side view of the ratchet wrench shown in FIG. 1, indicating the angular displacement of the second ratchet pawl;

FIG. 3 shows an end view of the ratchet wrench shown in FIG. 1, indicating a pair of axially displaced ratchet pawls;

FIG. 4 shows a second embodiment of the ratchet wrench having dual function tubes, which can slide to provide increased leverage both for the T-bar wrench and the ratchet wrench, as well providing comfortable hand grips when rotating their respective internal torque bars;

FIG. 5 shows a third embodiment of the ratchet wrench having two one-way ratchet mechanisms located outboard, adjacent to the ratchet wrench torque bar drive heads;

FIG. 6 shows a fourth embodiment of the ratchet wrench having two one-way ratchet mechanisms located inboard, adjacent to the longitudinal axis of the T-bar wrench torque bar;

FIG. 7 shows a fifth embodiment of the ratchet wrench having a dual function tube, which can slide to provide increased ratchet wrench leverage as well as providing increased reach for the T-bar torque bar, the lever bar of the T-bar wrench being optionally removable for compact storage purposes;

FIG. 8 is a cross-sectional view X-X of the ratchet wrench shown in FIG. 7, looking in the direction of the arrows;

FIG. 9 shows a sixth embodiment of the ratchet wrench similar to FIG. 4, except it can optionally be disassembled for compact storage purposes, by removing the lever bars of the T-bar wrench along with their integrally fitted tubes.

### DETAILED DESCRIPTION OF THE INVENTION

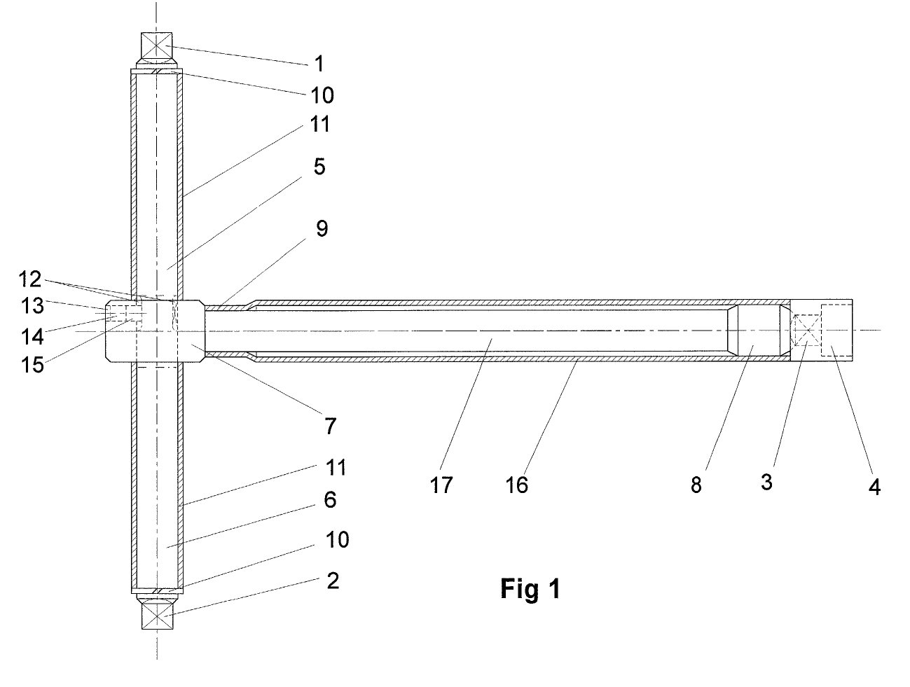

Referring to FIGS. 1 to 3, items 1, 2 and 3 are male drive sockets for optionally attaching a suitable socket head 4 for the tightening and/or loosening of nuts. The drive sockets shown are square but other arrangements are possible, for example, there might be hexagonal drive sockets.

The two in-line ratchet wrench torque bars 5 and 6 are disposed along the longitudinal axis of the ratchet mechanism and face in opposite directions. Also, in the embodiment shown, bars 5 and 6 are integrally connected to form a single component made from one piece of steel.

In the embodiment shown, housing 7 contains a one-way ratchet mechanism having two pawls 15 and 18. The first pawl 15 is held in contact with the ratchet teeth by a spring (not shown) retained by cap 13 within drilled hole 14. Similarly, the second pawl 18 is held in contact with the ratchet teeth by a spring (not shown) retained by cap 20 within drilled hole 19. The pawls 15 and 18 respectively engage axially displaced ratchet teeth. As shown, pawl 15 engages a first set of ratchet teeth 12, whereas, pawl 18 engages a second set of ratchet teeth (not shown).

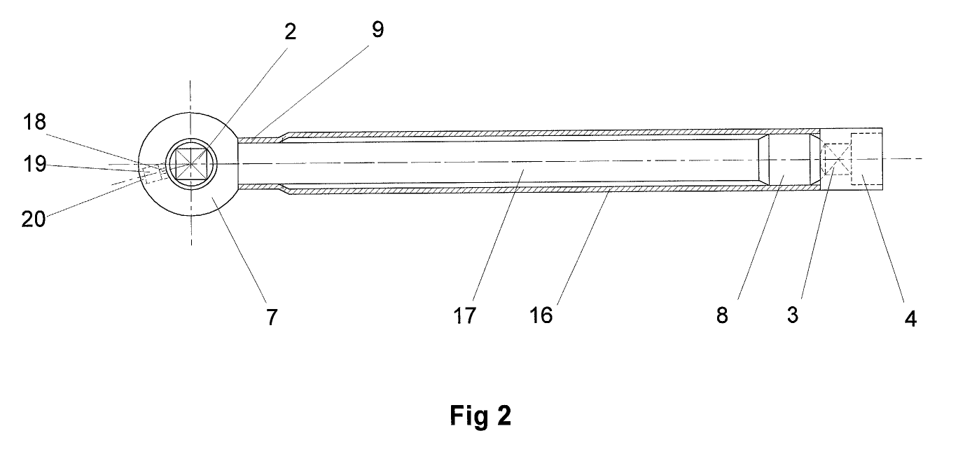

The two sets of ratchet have an angular displacement of one half of the common angle between the ratchet teeth on each set. For example, for a ratchet having a single set of 12 teeth, the angle between each tooth is 30 degrees and the two sets of ratchet teeth have an angular displacement of 15 degrees. The two ratchet pawls are displaced by the same radial angle of 15 degrees (as shown in FIG. 2) or an integer multiple of the angle. The advantage of this type of design is that the ratchet teeth can be deeply cut to provide a high strength tool combined with a more finely stepped ratchet mechanism. In the example, there are 12 deeply cut teeth in each set and a total of 24 ratchet steps.

Given that housing 7 contains a one-way ratchet mechanism, socket head 4 is attached to drive socket 1 for nut loosening and drive socket 2 for nut tightening; or, vice-versa, depending on the handing of the one-way ratchet. Alternatively, the housing 7 might contain a conventional two-way ratchet mechanism (not shown) allowing either of the drive sockets 1 or 2 to be used for both nut tightening and loosening. However, for the same overall dimensions, a one-way ratchet mechanism will be stronger (than a two-way ratchet) given that one face of the ratchet teeth can be cut in a radial direction parallel to the pawl.

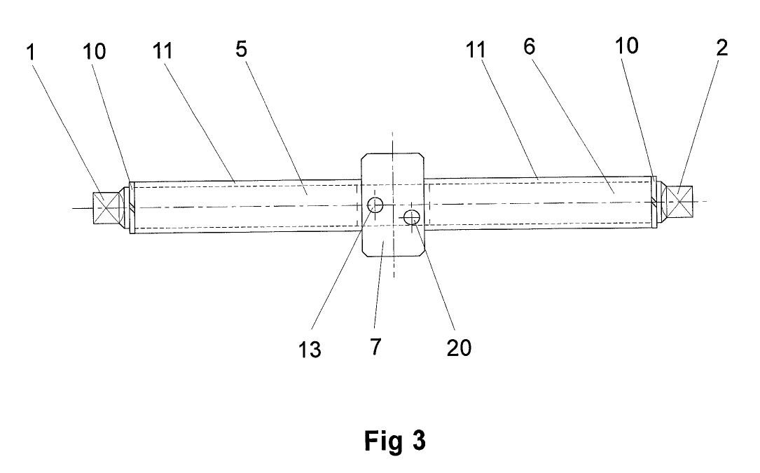

If socket head 4 is attached to say drive socket 1, to provide increased leverage, the tube 16 can be slid along the T-bar wrench torque bar 17 when functioning as the ratchet wrench lever bar, until the reduced diameter section 9 comes into contact with the increased diameter section 8. In order to steady the ratchet wrench, the tube 11 can be tightly gripped allowing the inner torque bar 6 to freely rotate through the same radial angle as bar 17. The tubes 11 are a sliding fit on torque bars 5 and 6 and thus are retained axially by spring clips 10, as shown in FIGS. 1 and 3.

Referring to FIG. 1, the T-bar may be used to tighten or loosen nuts via the attached socket head 4 (as shown) by applying leverage via the ratchet wrench torque bars (items 5 and 6) when functioning as the T-bar wrench lever bars. Given that tube 16 is a sliding fit on bar 17, the tube 16 can be tightly gripped allowing the T-bar wrench torque bar 17 to freely rotate through the same radial angle as the bars 5 and 6, for example, during nut spinning.

The bars 5, 6 and 17 thus serve dual functions depending on whether the integrated tool is being used as a ratchet wrench or a T-bar wrench. In other words, bars 5 and 6 can serve as torque bars for the ratchet wrench, or, combine to form the lever bars of the T-bar wrench. Similarly, bar 17 serves both as the torque bar for the T-bar wrench and as the lever bar for the ratchet wrench. Given that bar 17 is significantly longer that bar 5 or bar 6, the described tool provides the user with a single versatile hand tool having a variable reach, without the need to add an extension torque bar.

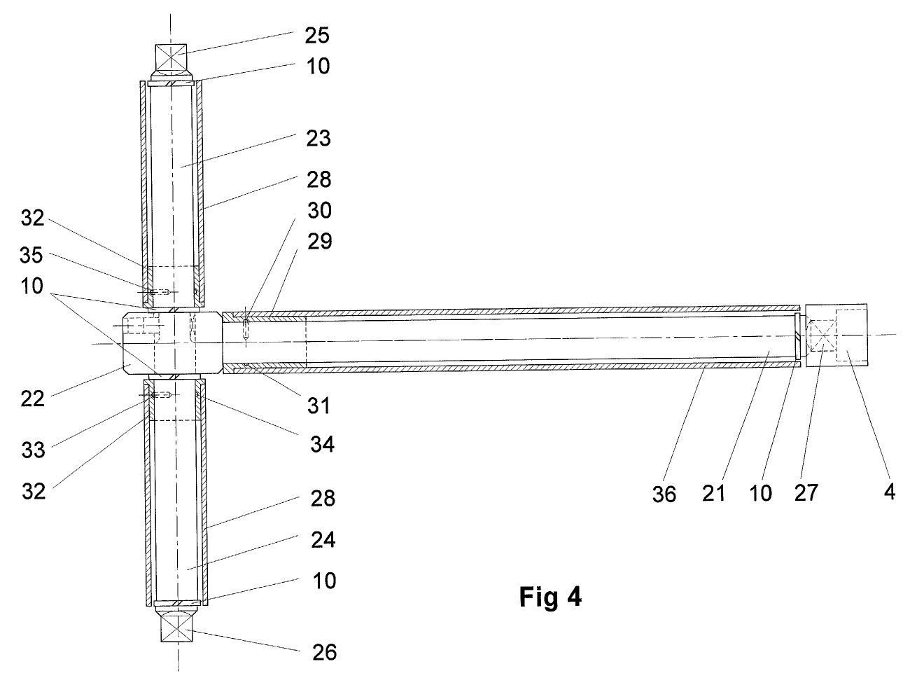

Referring to FIG. 4, drive sockets 25, 26 and 27 serve the same function as described for the corresponding items 1, 2 and 3 in the first embodiment; whereas, bars 23, 24 and 21 have dual functions as described for items 5, 6 and 17. Also, housing 22 could contain similar ratchet mechanism alternatives to the ones described for housing 7.

Each of the tubes 28 has a sleeve 32 permanently attached at one end, for example, sleeve 32 could be welded or glued in position. The sleeve 32 has an internal machined groove 34 locating on spring-loaded ball 33 housed in bar 24 and ball 35 housed in bar 23. The spring-loaded balls 33 and 35 prevent tubes 28 moving axially (unless they are firmly pulled) while allowing the torque bars 24 and 23 to freely rotate, if the respective tube 28 is tightly gripped. In the latter case, tubes 28 thus serve a similar function to tubes 11 in the first embodiment.

In addition, tubes 28 can be slid along the bars 24 and 23, until contact is made with the spring clips 10, to provide increased leverage for the T-bar wrench when socket head 4 is driven via torque bar 21.

Similar to tube 16 in the first embodiment, tube 36 can be slid along bar 21 to provided increased leverage for the ratchet wrench. However, the method of retaining tube 36 on bar 21 is similar to the foregoing description for tubes 28 and sleeve 29 has an internal groove 31 locating on spring-loaded ball 30. Sleeve 29 is longer than sleeves 32 due to the higher leverage potentially applied by tube 36 compared to a single tube 28.

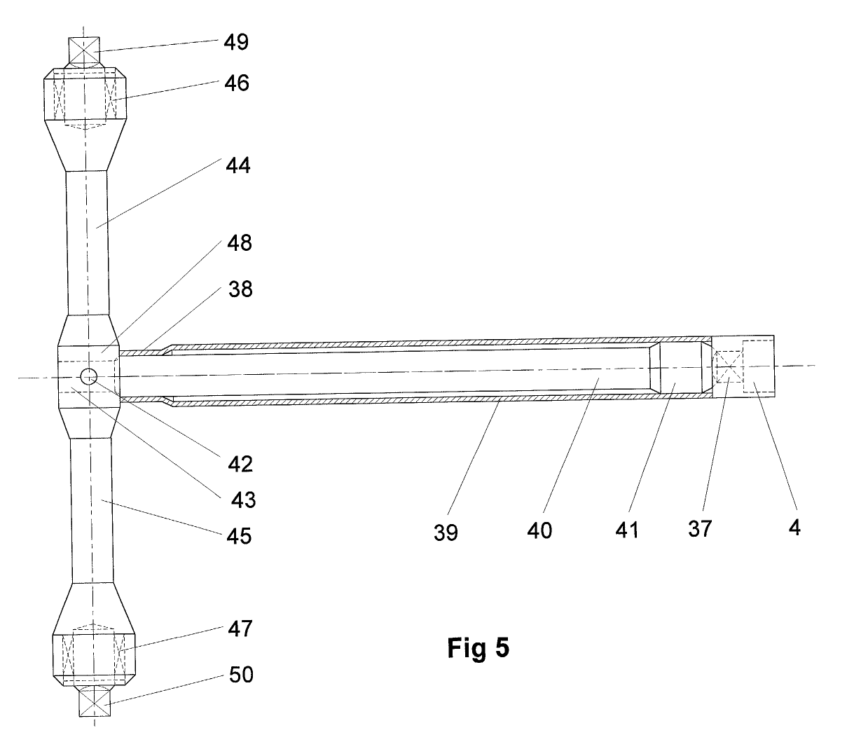

Referring to FIG. 5, items 39, 40, 41 and 37 correspond to the respective items 16, 17, 8 and 3 in the first described embodiment. However, bar 40 has a shaped end 43 for insertion into housing 48, bar 40 being retained in position by dowel 42.

Ratchet wrench torque (or, T-bar lever) bars 44 and 45 each have at their ends (outboard) one-way ratchet mechanisms 46 and 47, with retained stub shafts 49 and 50 having male drive sockets. As one ratchet is used for nut tightening nuts and the other ratchet for loosening nuts, this arrangement will tend to result in a longer ratchet life compared to a similarly sized single ratchet located at the point of intersection of the T-shaped configuration.

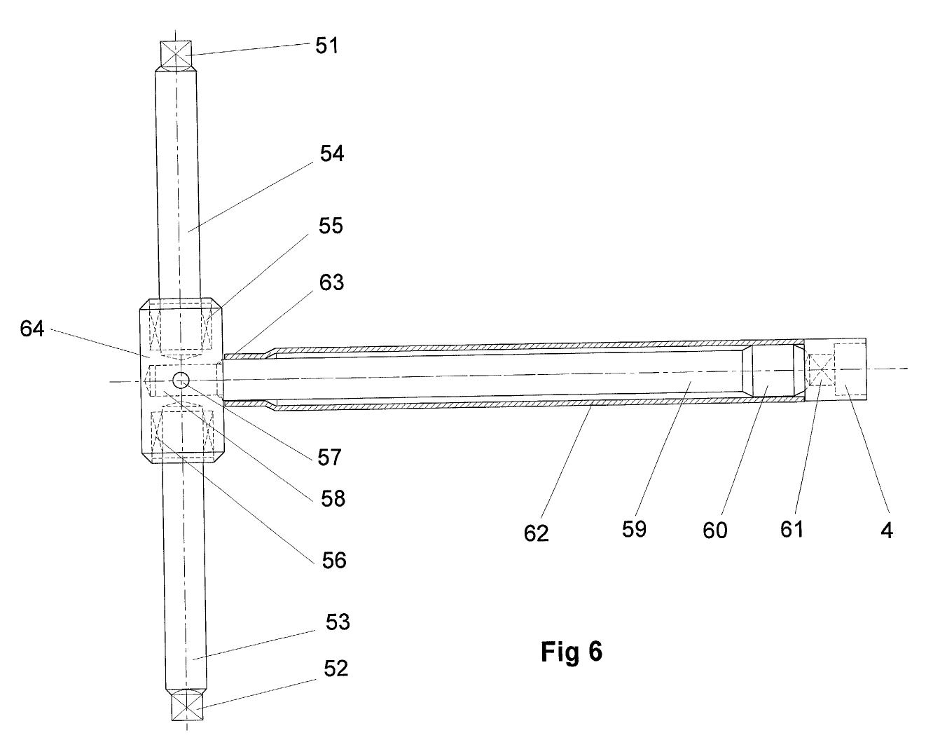

Referring to FIG. 6, as an alternative to the third embodiment, the ratchet torque bars 54 and 53 have one-way ratchet mechanisms 55 and 56 located inboard, namely, adjacent to the longitudinal axis of the T-bar wrench torque bar 59. However, other features of the embodiment are similar, with items 59 to 63 serving the same functions as items 37 to 41 in FIG. 5, with the shaped end 58 of bar 59 being retained in housing 64 by dowel 57.

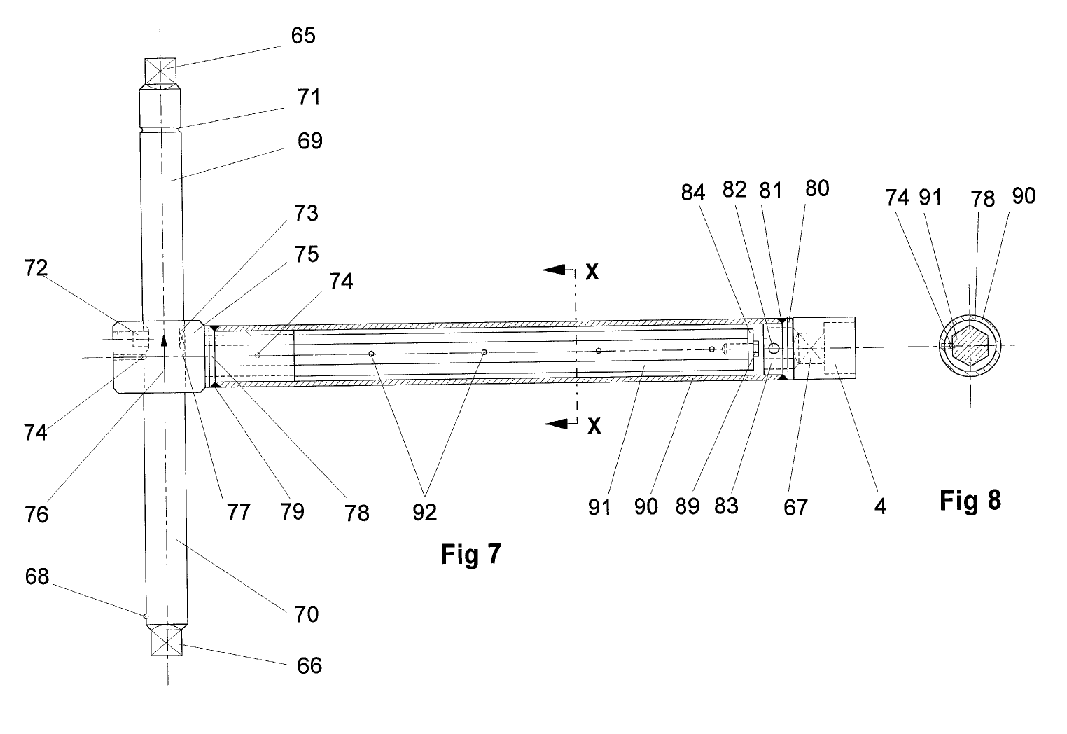

Referring to FIG. 7, bars 69 and 70 are integrally connected and may be optionally removed from housing 75 in order for the wrench to be compactly stored when not in use, with ball 68 preventing incorrect and arrow 76 encouraging correct re-assembly of the tool.

In the assembled position shown in FIG. 7, spring-loaded ball 74 locates in circumferential groove 77 to provide axial location for bars 69 and 70, when functioning as ratchet wrench torque bars, thus ensuring the ratchet pawl 72 is aligned with ratchet teeth 73. On the other hand, when bars 69 and 70 function as T-bar wrench lever bars, if preferred by the user, the spring-loaded ball can alternatively be located in groove 71, providing an L-shaped wrench. In a further embodiment (not shown), further circumferential grooves are machined at intervals along bars 69 and/or 70, to provide additional semi-fixed bar positions.

Referring to FIGS. 7 and 8, the T-bar torque bar 91 has an hexagonal cross-section as shown with sleeve 78 having an internally formed (for example, broached or forged) sliding fit on the hexagonal bar 91, with sleeve 78 being retained on bar 91 via plain washer 84. The sleeve 78 is attached to tube 90 via weld 79, with sleeve 80 similarly attached to the opposite end of tube 90 via weld 81.

During factory assembly of the ratchet wrench, washer 84 can be inserted sideways across the comers of the internal hexagon of sleeve 80 and then attached to bar 91 via bolt 89. The short hexagonal bar 83 (with integral male drive socket 67) is then inserted within sleeve 80 and retained by dowel 82.

When using the T-bar wrench, the foregoing described construction allows torque to be transmitted from bar 91 via tube 90 to male drive socket 67 and hence socket head 4 (when located in the position shown in FIG. 7) can be used to tighten or loosen nuts. In other words, the described T-bar torque bar assembly is of adjustable length allowing the reach of the T-bar to be optionally extended by the user. To provide increased axial stability, spring-loaded ball 74 can locate in various surface holes 92 positioned along the length of bar 91 (in the embodiment shown, there are five surface holes 92 in total).

In a further embodiment (not shown), the described method of construction for extending the reach of the T-bar wrench can similarly be applied to one or both of the ratchet wrench torque bars.

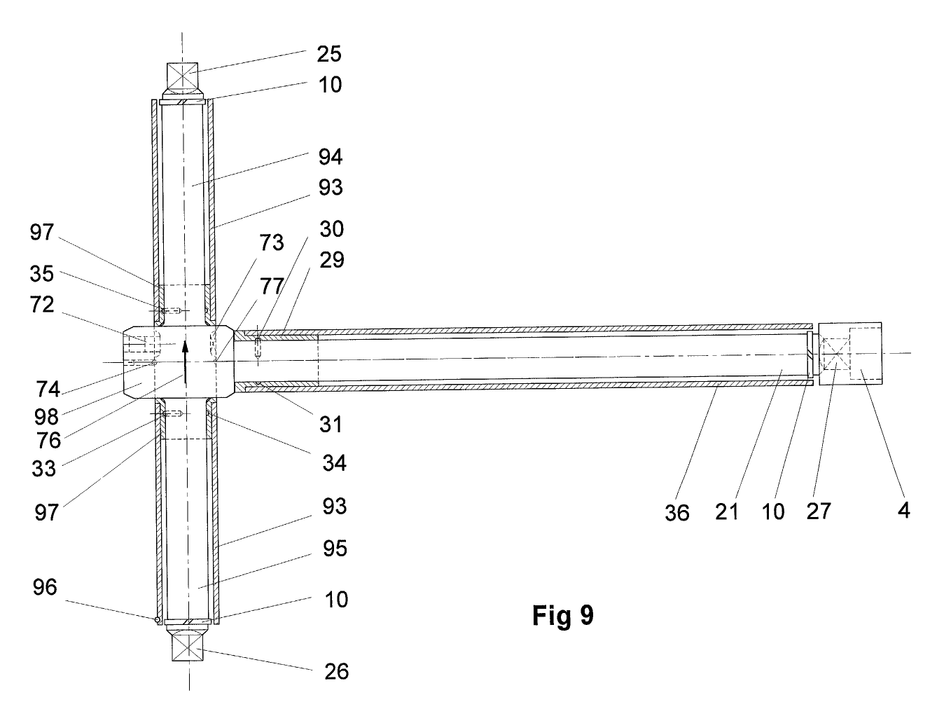

Referring to FIG. 9, housing 98 has been bored to provide a sliding fit for the dual function bars 94 and 95 with integrally connected tubes 93 so that the wrench can be disassembled for compact storage, with ball 96 preventing incorrect and arrow 76 encouraging correct re-assembly. Otherwise, FIG. 9 has similar constructional feature to the second embodiment shown in FIG. 4.

Referring again to FIG. 9, to prevent rotation of ratchet pawl 72 when the integrally connected torque bars 94 and 95 are removed and/or reassembled into housing 98, pawl 72 may be provided with a machined flat engaging a dowel (not shown) penetrating the flat side of housing 98 (the side facing in the direction of torque bar 94). A similar arrangement may be provided for ratchet pawl 72 shown in FIG. 7.

I claim the following:

1. A ratchet wrench having two oppositely facing torque bars which may be integrally connected, the torque bars being disposed along a common longitudinal axis, each torque bar having a drive head for engaging a suitable socket head; the torque bars combining to form the lever bars of an integral T-bar wrench having a single drive head for engaging a suitable socket head, the torque bar of the T-bar wrench being or capable of being when fully extended of significantly longer length than either of the ratchet wrench torque bars.

2. A ratchet wrench according to claim 1, wherein there are one or more non-adjustable ratchet mechanisms each having a one-way drive.

3. A ratchet wrench according to claim 1, wherein there is a single ratchet mechanism located at the point of intersection of the T-shaped configuration.

4. A ratchet wrench according to claim 3, wherein each ratchet mechanism has multiple sets of axially displaced ratchet teeth, each set having an angular displacement from the other set or sets by an amount nominally equal to the common angle between the ratchet teeth on each set divided by the number of sets of ratchet teeth.

5. A ratchet wrench according to claim 2, wherein two ratchet mechanisms are located along the common longitudinal axis of the ratchet wrench torque bars, there being one ratchet mechanism associated with each torque bar.

6. A ratchet wrench according to claim 5, wherein the ratchet mechanisms are located outboard, adjacent to the ratchet wrench torque bar drive heads.

7. A ratchet wrench according to claim 5, wherein the ratchet mechanisms are located inboard, adjacent to the point of intersection of the T-shaped configuration.

8. A ratchet wrench according to claim 1, wherein one or more of the ratchet wrench torque bars are fitted with tubes, each allowing its associated torque bar to freely rotate when the exterior of the tube is tightly gripped.

9. A ratchet wrench according to claim 1, wherein the T-bar wrench torque bar is fitted with a tube, allowing the torque bar to freely rotate when the exterior of the tube is tightly gripped.

10. A ratchet wrench according to any of the claim 1, wherein the T-bar wrench torque bar is of adjustable length to provide extended reach for the T-bar when engaging a suitable socket head, the said bar being capable of transmitting torque when extended.

11. A ratchet wrench according to claim 1, wherein one or more of the ratchet wrench torque bars are of adjustable length to provide extended reach for the ratchet wrench when engaging a suitable socket head, the said bar or bars being capable of transmitting torque when extended.

12. A ratchet wrench according to claim 1, wherein the T-bar wrench torque bar when functioning as the ratchet wrench lever bar is of adjustable length to provide increased leverage.

13. A ratchet wrench according to claim 1, wherein one or both of the ratchet wrench torque bars when functioning as the lever bars of the T-bar wrench are of adjustable length to provide increased leverage.

14. A ratchet wrench according to claim 2, wherein the ratchet wrench torque bars are integrally connected and are optionally removable for compact storage purposes, along with any integrally fitted tubes or means to provide adjustable length.

15. A ratchet wrench according to claim 14, wherein the integrally connected ratchet wrench torque bars when functioning as the lever bars of the T-bar wrench may be displaced along their common axis to one or more semi-fixed alternative positions.

16. A ratchet wrench according claim 14, wherein each of one or more ratchet pawls is provided with means to prevent pawl rotation when the integrally connected ratchet wrench torque bars are removed and/or re-assembled.
